(19) United States
(12) Patent Application Publication
(10) Pub. No.: US 2018/0246803 A1
(43) Pub. Date: Aug. 30, 2018

(54) TARGETED SOFTWARE TESTING

(71) Applicant: CA, Inc., New York, NY (US)

(72) Inventor: Yiting Zhang, Vancouver (CA)

(21) Appl. No.: 15/444,581

(22) Filed: Feb. 28, 2017

(51) Int. Cl. G06F 11/36

(52) U.S. Cl. CPC G06F 11/3672; G06F 11/3644

(57) ABSTRACT

To reduce the time for testing an application, a software testing system can identify and select test scripts that are targeted toward program code in the application which has been modified since a previous test. The software testing system performs a training phase in which each test script in a set of scripts is performed. The system monitors an application during performance of each test script to identify which program code of the application is executed or invoked during testing. The system associates each test script with an indication of which program code the test script executed. During a subsequent test, the system determines program code of the application that was modified. The system identifies test scripts that were previously determined to execute program code corresponding to the modified program code. The system performs the identified test scripts to test the modified program code of the application.

### BACKGROUND

The disclosure generally relates to the field of data processing, and more particularly to software development, installation, and management.

Software testing involves applying stimulus to an executing program or application to identify software bugs, identify errors, verify functionality, test capacity, or otherwise verify that the application is fit for an intended use. Testing an application may involve simulating user inputs, inputting test data, running the application in different environments (e.g., environments with varying amounts of resources, such as memory, bandwidth, storage, etc.), invoking functions or other program code of the application, etc. Testing can be performed manually or through execution of one or more test scripts designed to test various aspects of an application under test. A software development process typically includes multiple iterations of software testing as bugs/errors are identified and corrected in an application's program code.

### BRIEF DESCRIPTION OF THE DRAWINGS

Aspects of the disclosure may be better understood by referencing the accompanying drawings.

FIG. 1 depicts an example software testing system performing a training phase for a set of test scripts.

FIG. 2 depicts an example software testing system performing targeted testing of an application.

FIG. 3 depicts a flowchart with example operations for performing a training phase for a plurality of test scripts.

FIGS. 4 and 5 depict a flowchart with example operations for performing targeted testing for a modified application.

FIG. 6 depicts an example computer system with a targeted software testing system.

### DESCRIPTION

The description that follows includes example systems, methods, techniques, and program flows that embody aspects of the disclosure. However, it is understood that this disclosure may be practiced without these specific details. For instance, this disclosure refers to software testing in illustrative examples. Aspects of this disclosure can be also applied to testing of hardware such as computer systems, processors, data storage, etc. In other instances, well-known instruction instances, protocols, structures and techniques have not been shown in detail in order not to obfuscate the description.

Overview

Testing software for quality assurance purposes can require hundreds or thousands of test scripts. Performing a set of test scripts for an application can often take hours, preventing developers from receiving test feedback in a timely manner. To reduce the time for testing an application, a software testing system can identify and select test scripts that are targeted toward program code in the application which has been modified since a previous test. As a result, the application is adequately tested in less time since just a subset of test scripts are performed. The software testing system first performs a training phase in which each test script in a set of scripts is performed. The system monitors an application during performance of each test script to identify which program code of the application is executed or invoked during testing. The system then associates each test script with an indication of which program code the test script executed. During a subsequent test of the application, the system determines program code of the application that was modified. The system identifies test scripts that were previously determined to execute program code corresponding to the modified program code. The system performs the identified test scripts to test the modified program code of the application.

Terminology

The description below uses the term “program code” to refer to statements or words written in a particular programming language. Program code may be written in a variety of known languages such as C, C++, Java, Javascript, C#, Visual Basic, Python, Ruby, etc. Program code is compiled to create an executable version of the program code, which is referred to as an application. The application may be a software program, a script, a process, a virtual machine, etc.

The description below uses the term “modified program code” to refer to program code that has been edited, changed, or added as compared to a previous version of the program code. The term modified program code encompasses all modifications to program code across files, functions, or lines of the program code. A single instance of modified program code is referred to as a “program code modification.” For example, if lines 10-20 of a file were changed, the changes to lines 10-20 are referred to as a program code modification.

The description below uses the term “indication of program code” to refer to an identifier or expression which describes program code. For example, an indication of program code may be a function name, a file name, line numbers, a library name, etc. The indication of program code is used in place of the actual program code for efficiency and ease of analysis; however, in some implementations, the actual program code may be used. The term “indication of program code” is sometimes referred to as the indication of executed program code or indication of invoked program code. In these cases, the indication of program code is associated with a test script to described which program code is invoked or executed during performance of the test script.

Example Illustrations

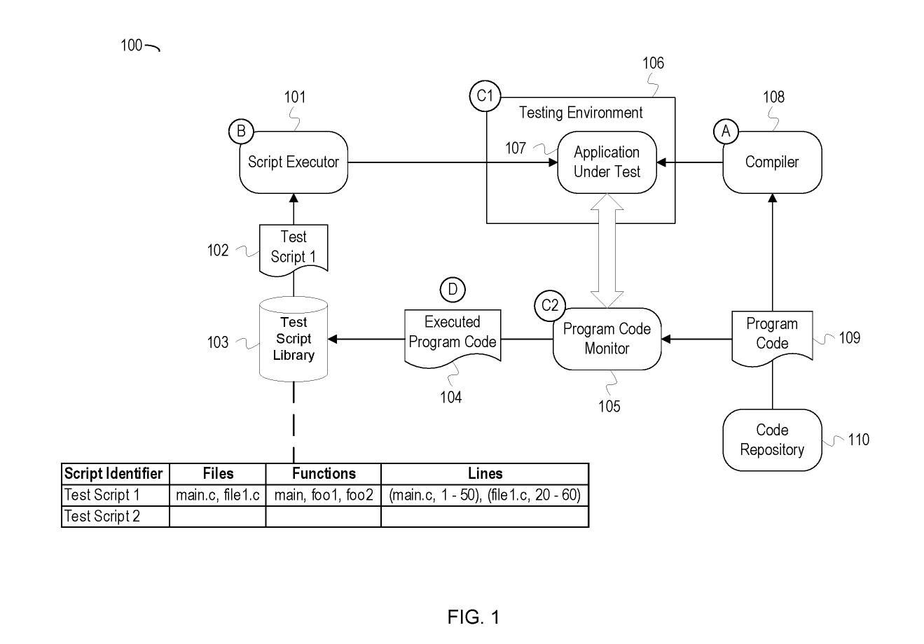

FIG. 1 depicts an example software testing system performing a training phase for a set of test scripts. FIG. 1 depicts a software testing system 100 that includes a script executor 101, a test script library 103, a program code monitor 105, a testing environment 106, a compiler 108, and a code repository 110. The testing environment 106 includes an application under test 107 (“application 107”).

At stage A, the compiler 108 compiles program code 109 to generate the application 107. The compiler 108 retrieves the program code 109 from the code repository 110. The code repository 110 is used by developers for managing source code for an application being developed. The code repository 110 may have various tools for committing/tracking code changes, tracking application versions, etc. The compiler 108 may be configured to periodically retrieve a most recent version of the program code 109 from the code repository 110 for testing. After retrieving the program code 109, the compiler 108 compiles the program code 109. The compiler 108 uses a compiler, such as a compiler from the GNU Compiler Collection (GCC), that corresponds to a language type (e.g., C, C++, Java) of the program code 109. Compiling the program code 109 results in an executable for the application 107. The compiler 108 deploys the application 107 in the testing environment 106 by loading and executing the executable for the application 107. The testing environment 106 may be a variety of computing environments such as a desktop, smartphone, virtual machine, server, etc. The testing environment 106 may include additional software tools such as agents or scripts for deploying, monitoring, debugging, or manipulating the application 107.

At stage B, the script executor 101 retrieves a test script 1 102 from the test script library 103. The test script library 103 includes a plurality of test scripts for testing applications. Some test scripts may be specific to the application 107 while others may be generic test scripts that may be used to test a variety of applications. Test scripts may be designed to test specific functionality of an application, monitor resource usage, perform load testing, etc. Test scripts may be written in various programming languages, such as Python, Ruby, etc. During an initial training phase, the script executor 101 iteratively selects each test script in the test script library 103 for execution. In FIG. 1, the script executor 101 begins the training phase by selecting the test script 1 102 for execution.

Stages C1 and C2 occur simultaneously. At stage C1, the script executor 101 performs the test script 1 102 on the application under test 107 within the testing environment 106. Performing the test script 1 102 can involve providing test data to the application 107, simulating user inputs, invoking specified functions, manipulating resources available to the application 107, etc.

At stage C2, the program code monitor 105 determines which program code of the program code 109 is executed during the performance of the test script 1 102. The program code monitor 105 receives the program code 109 from the code repository 110 in addition to the compiler 108. The program code monitor 105 may also receive the executable for the application 107 from the compiler 108 to create a mapping between lines of the program code 109 and binary instructions included in the executable. To create the mapping, the program code monitor 105 can use information generated by the compiler 108 such as a list of which binary instructions were generated as a result of compiling a specified line of code. The program code monitor 105 monitors instructions executed by a processor of the testing environment 106 to determine which lines of code in the program code 109 are executed as a result of performing the test script 1 102. The program code monitor 105 can monitor the executed instructions by monitoring a cache location for processor instructions or interposing an agent between a processor and an instruction pipeline to record executed instructions issued to the processor by the application 107. In some instances, the testing environment 106 may execute the application 107 in a debugging mode which allows for line by line execution of the program code 109.

The program code monitor 105 may also analyze the program code 109 to generate data structures to aid in monitoring the program code 109. For example, the program code monitor 105 may index functions or methods in the program code 109 or may generate a graph that indicates an interconnection of functions within the program code 109 (i.e. which functions invoke other functions). In other implementations, the program code monitor 105 may modify the program code 109 and then send the modified program code 109 to the compiler 108 prior to generating the application 107. The program code monitor 105 may instrument the program code 109 with additional logging functionality, breakpoints, code for monitoring variable values, etc. In such an implementation, the compiler 108 compiles the program code 109 as modified by the program code monitor 105. In some instances, the program code 109 can be compiled using a technique that incorporates bytecode identifiers in the executable binary which correspond to lines of code in the program code 109. For instance, the Java programming language allows for this functionality. In such instances, the program code monitor 105 may retrieve the executable for the application 107 and any other data needed to generate a mapping between lines of code in the program code 109 and the bytecode identifiers from the compiler 108. The program code monitor 105 monitors the binary instructions being executed by a processor in the testing environment 106 for bytecodes and uses the mapping to determine which lines of the program code 109 are being executed within the testing environment 106.

At stage D, the program code monitor 105 associates indications of the executed program code 104 with the test script 1 102 in the test script library 103. The program code monitor 105 records which lines of code of the program code 109 were executed in the executed program code 104. As depicted in the example data of FIG. 1, the program code monitor 105 may indicate the executed program code 104 at various levels of granularity: file, function, and line. The file level indicates that the files “main.c” and “file1.c” contained programmed code that was executed during performance of the test script 1 102. The function level indicates that the “main”, “foo1”, and “foo2” functions were invoked during the test script 1 102. The line level indicates that lines 1-50 of the file “main.c” and lines 20-60 of the file “file1.c” were executed. The program code monitor 105 may also indicate other aspects or characteristics of the executed program code 104. For example, the program code monitor 105 may indicate a number of times each file, function, or line was executed; variables which were initialized or modified; libraries that were used; application programming interfaces for third party applications that were invoked, etc. The program code monitor 105 associates the indications of the executed program code 104 by storing the indications in a data structure along with an identifier for the test script 1 102. For example, the program code monitor 105 may store the indications of the executed program code 104 in a database, a table in storage, etc. Alternatively, the program code monitor 105 may store the indications of the executed program code 104 in metadata or header information of the test script 1 102.

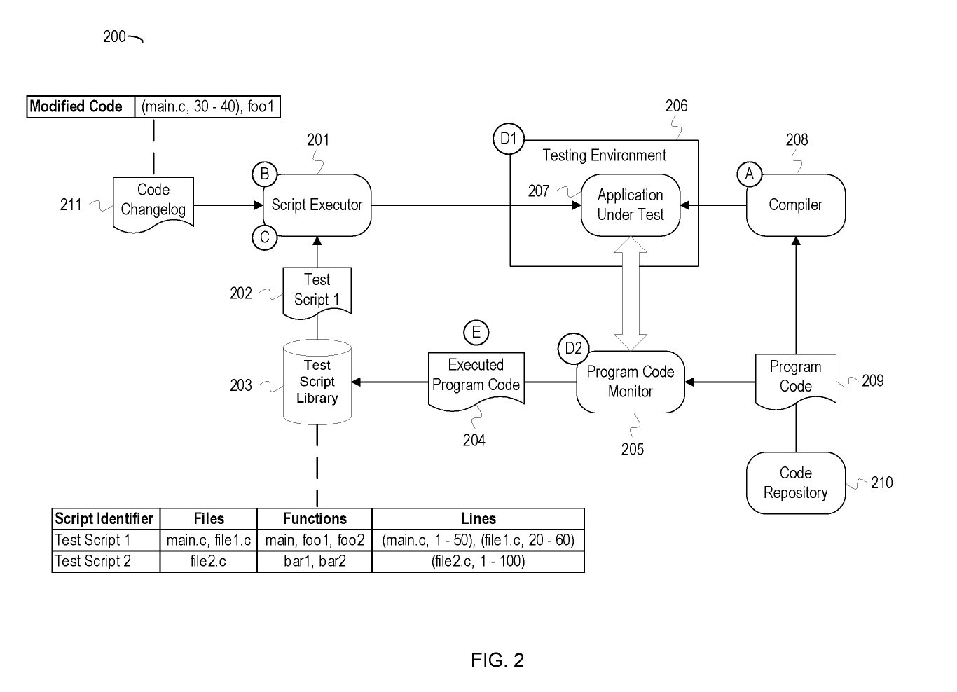

After the indications of the executed program code 104 have been associated with the test script 1 102, stages B-D are repeated for another test script in the test script library 103. For example, the script executor 101 may select for execution a “Test Script 2” from the test script library 103 which has yet to be associated with indications of executed program code. This process continues until the training phase is complete. Once the software testing system 100 has completed the training phase, future testing can be completed in less time by executing only those test scripts which have been determined to invoke program code that has been modified. This process is described in detail in FIG. 2.

FIG. 2 depicts an example software testing system performing targeted testing of an application. FIG. 2 depicts a software testing system 200 that includes a script executor 201, a test script library 203, a program code monitor 205, a testing environment 206, a compiler 208, and a code repository 210. The testing environment 206 includes an application under test 207 (“application 207”).

At stage A, the compiler 208 compiles the program code 209 retrieved from the code repository 210. The program code 209 is an updated or modified version of the program code 109 described in FIG. 1. For example, developers may have corrected bugs, added functionality, or otherwise modified the program code 109. The compiler 208 compiles the program code 209 to generate the application 207 in a manner similar to that of the compiler 108 when compiling the program code 109. The compiler 208 also deploys the application 207 in the testing environment 206.

At stage B, the script executor 201 receives a code changelog 211. The code changelog 211 indicates code in the program code 209 that has been modified since a previous version or iteration of the program code 209. The code changelog 211 can be generated by the code repository 210 and transmitted to the script executor 201. Alternatively, in some instances, another process of the software testing system 200 generates the code changelog 211 by comparing the program code 209 to program code that was previously tested or program code that was used during a training phase. The code changelog 211 may indicate modifications or additional code at different levels of granularity, such as file, function, line, etc.

At stage C, the script executor 201 analyzes the code changelog 211 to determine which test scripts to retrieve from the test script library 203. In order to reduce a length of time required to test the application 207, the script executor 201 identifies test scripts in the test script library 203 that target the modified code identified in the code changelog 211. In the illustration of FIG. 2, the script executor 201 first determines that the code changelog 211 indicates that lines 30-40 of the file “main.c” have been modified. The script executor 201 queries the test script library 203 using the file name and line numbers to identify test scripts which were previously determined to execute those lines of code. The script executor 201 determines that the test script 1 202 is indicated as causing the modified lines of code to be executed and adds the test script 1 202 to a queue of test scripts to be executed. The script executor 201 then determines that the code changelog 211 indicates that the function “foo1” has been modified. The script executor 201 queries the test script library 203 using the function name to identify test scripts which were previously determined to execute that function. The script executor 201 determines that the test script 1 202 is also indicated as causing the modified function to be executed and, since the test script 1 202 is already in the queue, no additional test scripts are added. The script executor 201 does not add the “Test Script 2” (depicted in the example data for the test script library 203) to the queue since none of the code which is executed by the “Test Script 2” is indicated as modified in the code changelog 211.

After identifying and adding test scripts to the queue, the script executor 201 may perform all test scripts in the queue and output test results. However, in some implementations, the adequacy and thoroughness of the test scripts in testing the modified program code indicated in the code change log 211 may be determined by performing stages D1, D2, and E as described below.

Stages D1 and D2 occur simultaneously. At stage D1, the script executor 101 performs the test script 1 202 on the application 207 within the testing environment 206. The script executor 201 performs the test script 1 202 in a manner similar to the script executor 101 described in FIG. 1. At stage D2, the program code monitor 205 determines which code in the program code 209 is executed during the performance of the test script 1 202. The program code monitor 205 monitors execution of the program code 209 and generates indications of executed program code 204 in a manner similar to that of the program code monitor 105 described in FIG. 1.

At stage E, the program code monitor 205 compares the executed program code 204 to the execute program code indicated for the test script 1 202 in the test script library 203. The program code monitor 205 determines whether the indications of executed program code match based on the comparison. If the indications match, the program code monitor 205 determines that the test script 1 202 was successful in testing the indicated code. If the indications do not match, the program code monitor 205 determines whether additional testing is needed to sufficiently test the modified code indicated in the code changelog 211. For example, the test script 1 202 is indicated in the test script library 203 as executing lines 1-50 of the file “main.c” based on a previously performed training phase. However, the program code monitor 205 may determine at stage D2 that only lines 1-20 of the file “main.c” were executed. As a result, the program code monitor 205 notifies the script executor 201 that the test script 1 202 failed to sufficiently test the modified code indicated in the code changelog 211 since the modified lines 30-40 were not executed. In response to this notification, the script executor 201 may search for additional test scripts to perform or may provide an error message indicating that the modified code was not sufficiently tested. If the indications of executed code do not match, the program code monitor 205 may also update the indication of executed code for the test script 1 202 to match the executed program code 204.

FIGS. 1 and 2 are annotated with a series of letters A-D and A-E, respectively. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

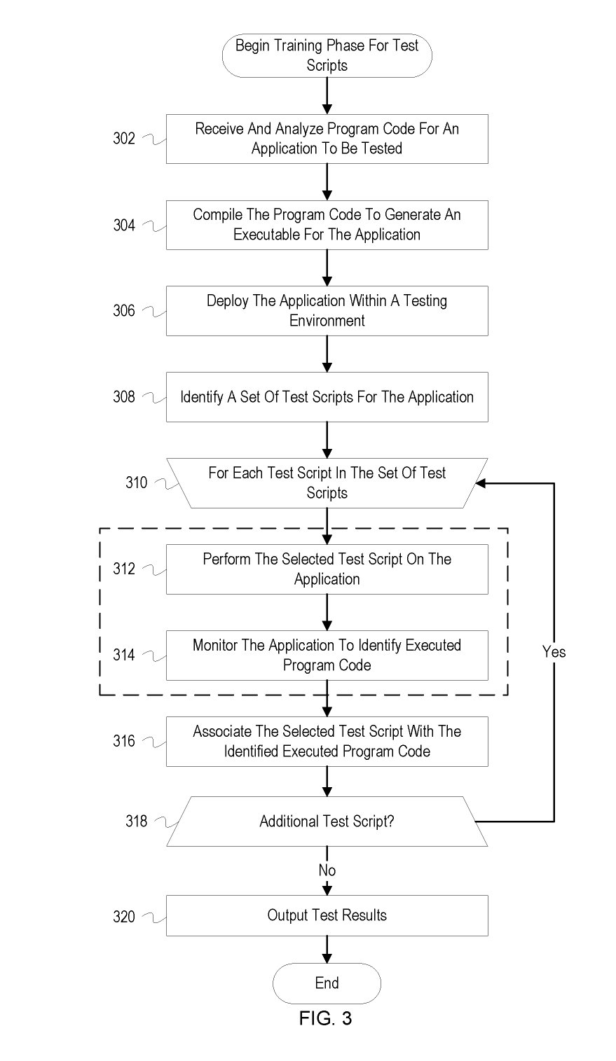

FIG. 3 depicts a flowchart with example operations for performing a training phase for a plurality of test scripts. FIG. 3 describes a software testing system as performing the operations for naming consistency with FIGS. 1 and 2, although naming of program code can vary among implementations.

A software testing system (“system”) receives and analyzes program code for an application to be tested (302). The system may receive the program code from a code repository which manages the program code for the application. The system may analyze the program code to identify functions, variables, files, libraries, APIs, etc. The system may also modify the program code to insert breakpoints, add code for monitoring variable values, or otherwise instrument the program code to enable the system to monitor the application during execution.

The system compiles the program code to generate an executable for the application (304). The system compiles the program code using a compiler that corresponds to the language of the program code. During or after compilation, the system may also map binary instructions generated during compilation to corresponding lines in the program code. Additionally, the system may track bytecode or binary identifiers as allowed by the compiler or programming language.

The system deploys the application within a testing environment (306). The testing environment may be a same computer that is executing the system, a different computer, a server, a smartphone, a tablet, etc. The system may install an operating system, create a virtual machine, load test data, etc., within the testing environment. The system may also enable a debugging mode, install agents or probes, or otherwise modify the testing environment to aid in monitoring of the application.

The system identifies a set of test scripts for the application (308). Each test script can include program code, instructions, data, or other information for testing various aspects and functionality of the application. The set of test scripts may have been created by a developer, an administrator, a software testing application, etc. Each test script may be associated with metadata or header information that indicates characteristics of the test script such as how long the test script takes to execute, which aspects of the application the test script is designed to test, or any prerequisites for executing the test script. Additionally, if the system has previously performed training with a test script, the test script may be associated with data that indicates program code which is executed or invoked by the test script.

The system begins executing and monitoring each of the test scripts to identify program code which is executed by the test script (310). The test script currently being executed is hereinafter referred to as “the selected test script.”

As indicated by the dashed-line box in FIG. 3, the system simultaneously performs the selected test script on the application (312) and monitors the application to identify executed program code (314). The system may perform the selected test script by compiling and executing program code in the test script, loading test data indicated in the script, simulating user input, etc. During performance of the test script, the system monitors execution of the application within the testing environment. The system may install an agent or initiate a kernel process to monitor instructions from the application that are executed by a processor, loaded in the instruction pipeline, or stored in cache for execution. The system may parse the processor instructions to identify bytecodes or binary identifiers corresponding to lines in the program code. The system may use a bytecode mapping generated during compilation of the program code to identify the executed portions of program code. If the program code was instrumented with breakpoints or variable monitoring functionality, the system maintains a list of which breakpoints or variables were encountered and their locations in the program code to determines which program code was executed. The system may track executed program code at different levels of granularity. For example, the system may only monitor the application for invocation of different functions or methods within the program code. The system may also track performance metrics for each function such has how many times a function was invoked, time taken to execute a function, or resources consumed during execution of the function.

The system associates the selected test script with the identified executed program code (316). The system can indicate executed program code by indicating which lines of which files were executed, which functions were invoked, which variables were encountered, which libraries were used, or a combination of one or more of the foregoing. The executed program code may be indicated using various data structures such as integers for line numbers, strings for file and function names, ranges for sequential line numbers, a linked list or tree for function invocations, etc. The system can associate the indications of the executed program code with an identifier for the selected test script in a database, table, or other data structure. Any performance metrics collected by the system during performance of the selected test script can similarly be associated with the selected test script or with an indication of executed program code which corresponds to a performance metric.

The system determines whether there is an additional test script (318). If there is an additional test script, the system selects the next test script (310). If there is not an additional test script, the system outputs the test results (320). Even though the system is performing a training phase, the system may still monitor the test scripts and output test results for the application under test. The test results can include performance metrics, identified bugs, data validation errors, etc. Additionally, the system can analyze the executed program code associated with each of the test scripts to determine whether the application was sufficiently tested. For example, the system may compare the identified executed program code with the program code for the application to determine whether any lines, functions, or files were not executed or accessed during the performance of the set of test scripts. If any lines, functions, or files were not executed, the system may provide an error message or otherwise indicate in the test results that the application was not fully tested.

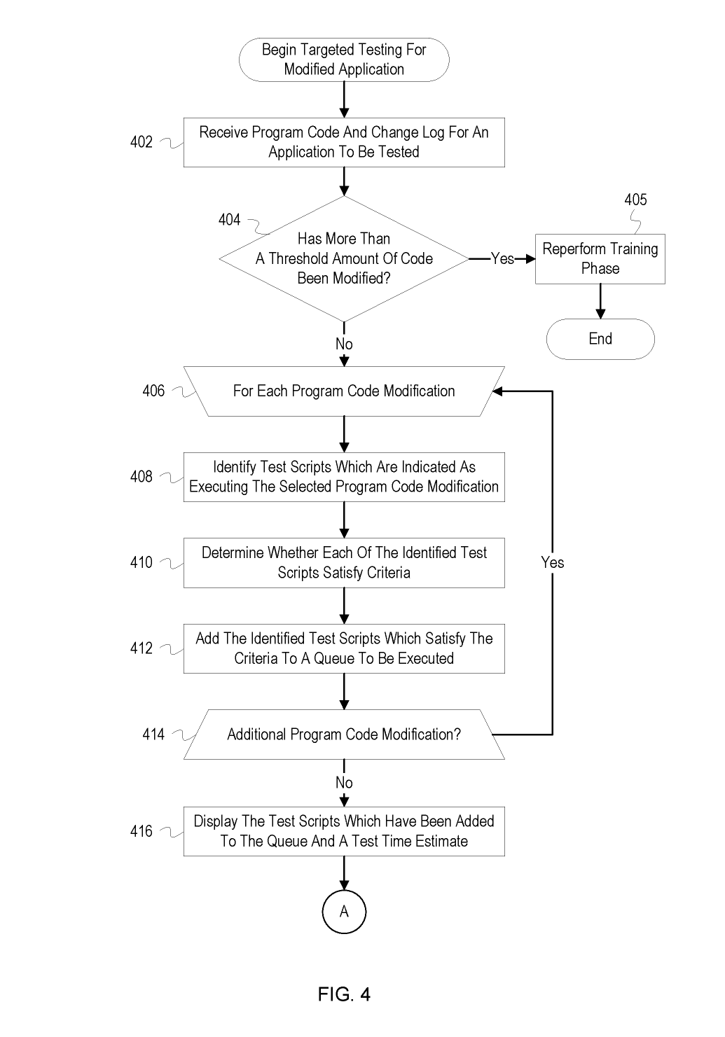

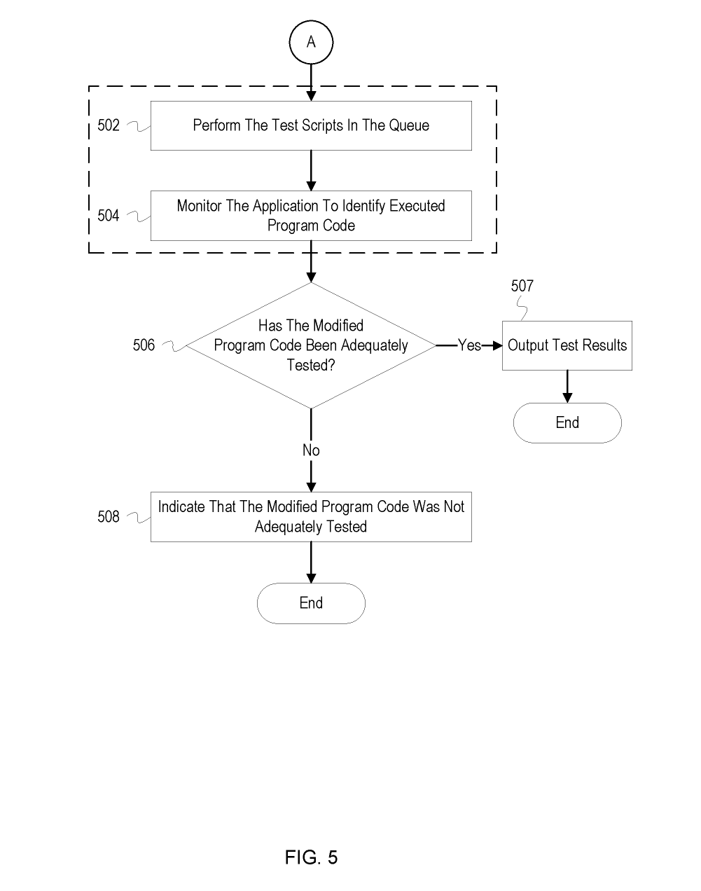

FIGS. 4 and 5 depict a flowchart with example operations for performing targeted testing for a modified application. FIGS. 4 and 5 describe a software testing system as performing the operations for naming consistency with FIGS. 1 and 2, although naming of program code can vary among implementations.

A software testing system (“system”) receives program code and a changelog for an application to be tested (402). The system may retrieve a latest version of program code for the application from a code repository. Additionally, the system may retrieve the changelog indicating modified and new program code from the code repository. In some implementations, the system may generate the changelog based on a comparison of the received program code to program code that was previously tested. The changelog can indicate modified program code using line numbers, file names, or function names. The changelog can also indicate new functions, new files, and new lines of code. In some implementations, the system updates indications of executed program code associated with test scripts based on the changelog. For example, a test script may be associated with an indication of program code for lines 20-40. If the changelog indicates that two new lines of code were added before line 20, the system updates the indication to be lines 22-42.

The system determines whether more than a threshold amount of program code has been modified (404). If a significant amount of program code has been modified, the system may be unable to identify test scripts which will sufficiently test the application because the indications of executed program code associated with the test scripts may no longer be applicable. The threshold may be a number of new or modified lines, a number of new or modified functions, a number new or modified files, a percentage of the overall program code which was modified, etc. In some implementations, the system may also analyze the program code to identify the type of modifications. For example, if a new file is added to the program code, the system will not have previously identified test scripts which will cause the program code in the new file to be executed. Conversely, if only existing functions or files are modified in the program code or if new code is added to an existing function, file, or library, the system can use the previously determined indications of program code associated with the test scripts to identify test scripts for testing the modified program code in the application.

If the program code has changed more than the threshold amount, the system reperforms the training phase (405). Also, if new files or functions are added to the program code, the system may trigger a reperformance of the training phase. The system reperforms the training phase because test scripts for sufficiently testing the application are unlikely to be identified due to new program code or significant program code modifications. The system again performs each of the test scripts in a test script library to determine which program code is executed by a test script. In some implementations, the system may only reperform the training phase for test scripts which have not been executed for a specified time period, test scripts which are indicated as executing the program code that has been modified, or test scripts that are indicated as critical or important. The system performs the training phase operations in a manner similar to that described in reference to FIG. 3. After reperforming the training phase, the process ends.

If the program code has changed less than the threshold amount, the system begins identifying test scripts to test each program code modification identified in the changelog (406). The system may identify program code modifications at different levels of granularity. For example, the system may use the changelog to determine each function within the program code that has been modified. The system then iterates through each modified function to identify test scripts which test the selected function. The program code modification for which a test script is being identified is hereinafter referred to as “the selected program code modification.”

The system identifies one or more test scripts which are indicated as invoking or executing the selected program code modification (408). The system may query the test script library or other data structure which includes a mapping of test script identifiers to indications of program code. The system performs the query using the selected program code modification. For example, the selected program code modification may indicate that the function “foo1” was modified. The system queries or searches the library using the function name “foo1” to identify one or more test scripts which cause the function “foo1” to be tested/executed.

The system determines whether each of the identified test scripts satisfy criteria (410). In order to test the modified program code as efficiently as possible, the system can apply criteria to eliminate some test scripts from the one or more identified test scripts. For example, some test scripts may only invoke the selected program code modification incidentally as opposed to being designed or intended to test the selected program code. The system can attempt to identify test scripts which are designed to test the selected program code modification by, for example, analyzing characteristics such as how many times the selected program code modification is executed/invoked by the test script. If a test script executes the selected program code modification less than a threshold number of times, the system may determine that the test script was not designed for testing the selected program code modification and eliminate the test script. Alternatively, if the test script executes the selected program code modification more than the threshold number, the system retains the test script as a test script to be executed. The system may also eliminate redundant test scripts (e.g. two test scripts which test the selected program code modification in a similar manner) or test scripts that are of low importance, such as test scripts that test resource consumption or some basic functionality.

The system adds the identified test scripts which satisfy the criteria to a queue to be executed (412). As the system iterates through the program code modifications, the system constructs the queue of test scripts to be executed. If a test script is not already present in the queue, the system adds the test script to the queue. The resulting queue includes a subset of test scripts from the test script library which will be performed to test the modified program code. The system may also associate each test script with an indication of the selected program code modification to track which modification each test script was intended to test. This information may later be used by the system when monitoring performance of the test script to determine whether a program code modification was sufficiently tested.

The system determines whether there is an additional program code modification (414). If there is an additional program code modification, the system selects the next program code modification (406).

If there is not an additional program code modification, the system displays the test scripts which have been added to the queue and a test time estimate (416). The system may display the queue of test scripts to allow for tests scripts to be added or eliminated from the queue. The system also displays an estimated time it will take to perform the test scripts in the queue. The system can determine the time it takes for each test script to execute during the training phase described in FIG. 3. The system can then determine an estimated time for the queue by summing the performance times for each test script in the queue.

As indicated by the reference letter A, the flowchart of FIG. 4 continues to FIG. 5. As indicated by the dashed-line box in FIG. 5, the system simultaneously performs the selected test script on the application (502) and monitors the application to identify executed program code (504). The system performs these operations in a manner similar to that described in reference to operations 312 and 314 of FIG. 3. The system similarly generates a list or other indication of the program code that was executed during the performance of each test script.

The system determines whether the modified program code has been adequately tested (506). The system can compare the changelog to the indication of executed program code to determine whether each program code modification was executed during performance of the test scripts. If each program code modification was executed, the system determines that modified program code was adequately tested. If each program code modification was not executed, the system determines that the modified program code was not adequately tested.

If the modified program code has been adequately tested, the system outputs the test results (507). The test results are output in a manner similar to that described at operation 320 of FIG. 3. After outputting the test results, the process ends.

If the modified program code has not been adequately tested, the system indicates that the modified program code was not adequately tested (508). The system can analyze one or more program code modifications which were not tested and determine whether the program code modifications were not executed as a result of an error. For example, the system can identify a test script which was intended to test an unexecuted program code modification and determine whether the test script fully executed or whether the test script halted early due to an error. The system outputs any unexecuted program code modifications and any errors related to the unexecuted program code modifications. After indicating that the modified program code was not adequately tested, the process ends.

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 314 and 316 of FIG. 3 can be performed in parallel or concurrently. Additionally, the operations depicted in block 416 of FIG. 4 and blocks 504 and 506 of FIG. 5 may not be performed. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

Some operations above iterate through sets of items, such as test scripts or program code modifications. In some implementations, test scripts may be iterated over according to an ordering of test scripts, an indication of test scripts importance, a duration associated with each test script, etc. Program code modifications may be iterated over based on an ordering of the modifications, a level of granularity of the modification, a size of the modification (e.g. a number of lines), etc. The number of iterations for loop operations may vary. Different techniques for performing test scripts or analyzing program code modifications may require fewer iterations or more iterations. For example, multiple test scripts may be performed in parallel. Similarly, some program code modifications may be analyzed in parallel or identified as redundant.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

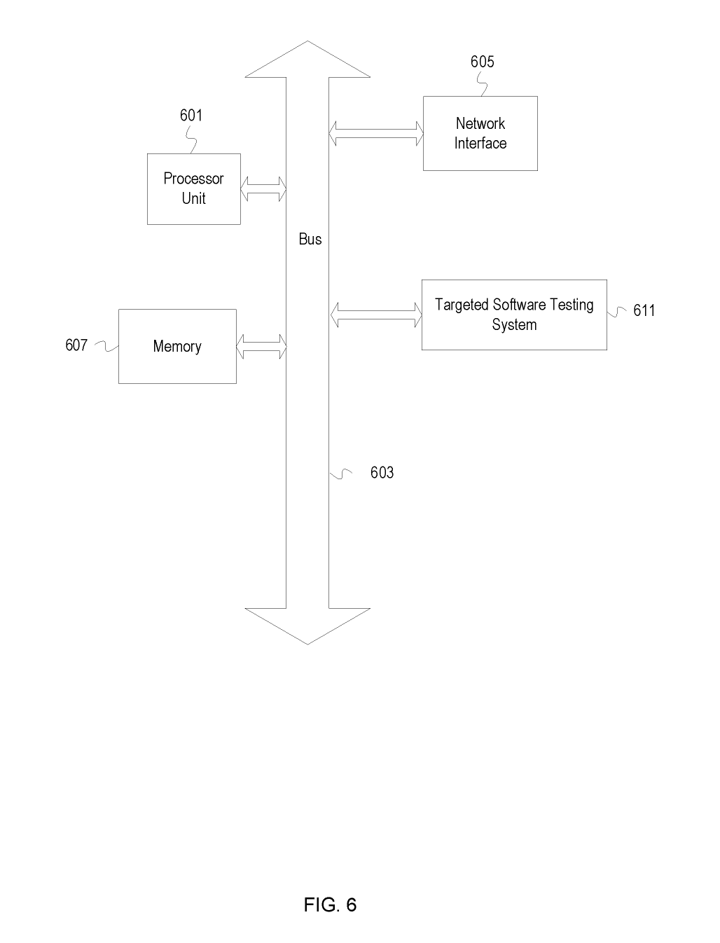

FIG. 6 depicts an example computer system with a targeted software testing system. The computer system includes a processor unit 601 (possibly including multiple processors, multiple cores, multiple nodes, and/or implementing multi-threading, etc.). The computer system includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 603 (e.g., PCI, ISA, PCI-Express, HyperTransport® bus, InfiniBand® bus, NuBus, etc.) and a network interface 605 (e.g., a Fiber Channel interface, an Ethernet interface, an internet small computer system interface, SONET interface, wireless interface, etc.). The system also includes a targeted software testing system 611. The targeted software testing system 611 efficiently tests applications by targeting test script selections based on recent program code modifications. Any one of the previously described functionalities may be partially (or entirely) implemented in hardware and/or on the processor unit 601. For example, the functionality may be implemented with an application specific integrated circuit, in logic implemented in the processor unit 601, in a co-processor on a peripheral device or card, etc. Further, realizations may include fewer or additional components not illustrated in FIG. 6 (e.g., video cards, audio cards, additional network interfaces, peripheral devices, etc.). The processor unit 601 and the network interface 605 are coupled to the bus 603. Although illustrated as being coupled to the bus 603, the memory 607 may be coupled to the processor unit 601.

While the aspects of the disclosure are described with reference to various implementations and exploitations, it will be understood that these aspects are illustrative and that the scope of the claims is not limited to them. In general, techniques for targeted software testing as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
associating each test script of a set of test scripts with an indication of program code invoked by the test script, wherein the indications correspond to portions of a first program code for an application;
based on receipt of modified program code, determining a plurality of program code modifications;
identifying a subset of the set of test scripts based, at least in part, on a comparison of the plurality of program code modifications to the indications of program code associated with the set of test scripts; and
executing the subset of test scripts to test the application.

2. The method of claim 1, wherein associating each test script of a set of test scripts with the indication of program code invoked by the test script comprises:
for each test script in the set of test scripts,
executing the test script on the application;
monitoring the application during execution of the test script to identify program code of the first program code which is executed; and
associating the test script with the identified program code.

3. The method of claim 2, wherein monitoring the application during execution of the test script to identify program code of the first program code which is executed comprises at least one of:
executing the application in a debugging mode;
monitoring an instruction pipeline of a processor executing the application; and
initiating an agent to record instructions issued to the processor by the application.

4. The method of claim 2 further comprising:
instrumenting the first program code with a plurality of breakpoints;
wherein monitoring the application during execution of the test script to identify program code of the first program code which is executed comprises identifying which breakpoints are encountered during execution of the test script.

5. The method of claim 1 further comprising eliminating a first test script from the subset of test scripts based, at least in part, on the first test script failing to invoke a first program code modification of the plurality of program code modifications more than a threshold number of times.

6. The method of claim 1 further comprising:
monitoring the application during execution of the subset of test scripts to identify executed program code; and
based on determining that the executed program code does not comprise all of the plurality of program code modifications, indicating that the application was not adequately tested based, at least in part, on not all of the plurality of program code modifications being tested.

7. The method of claim 1, wherein identifying the subset of the set of test scripts comprises:
for each program code modification in the plurality of program code modifications,
querying the indications of program code associated with the set of test scripts using an indication of the program code modification;
identifying a first test script of the set of test scripts for which the indication of program code corresponds to the indication of the program code modification; and
adding the first test script to the subset of test scripts.

8. The method of claim 1, wherein determining the plurality of program code modifications comprises:
comparing the modified program code to the first program code; and
determining the plurality of program code modifications based, at least in part, on the comparing.

9. The method of claim 1 further comprising, based on determining that the plurality of program code modifications exceeds a threshold, executing the set of test scripts to update the indication of program code associated with each test script.

10. One or more non-transitory machine-readable media comprising program code for performing targeted testing of an application, the program code to:
for each test script in a set of test scripts,
monitor execution of the test script to identify program code of the application which is executed by a processor;
associate the test script with an indication of the identified program code;
based on receipt of modified program code, determine a plurality of program code modifications;
identify a subset of the set of test scripts based, at least in part, on a comparison of the plurality of program code modifications to the indications of program code associated with the set of test scripts; and
execute the subset of test scripts to test the application.

11. The machine-readable media of claim 10, wherein the program code to identify the subset of the set of test scripts comprises program code to:
for each program code modification in the plurality of program code modifications,
query the indications of program code associated with the set of test scripts using an indication of the program code modification;
identify a first test script of the set of test scripts for which the indication of program code corresponds to the indication of the program code modification; and
add the first test script to the subset of test scripts.

12. An apparatus comprising:
a processor; and
a machine-readable medium having program code executable by the processor to cause the apparatus to,
associate each test script of a set of test scripts with an indication of program code invoked by the test script, wherein the indications correspond to portions of a first program code for an application;
based on receipt of modified program code, determine a plurality of program code modifications;
identify a subset of the set of test scripts based, at least in part, on a comparison of the plurality of program code modifications to the indications of program code associated with the set of test scripts; and
execute the subset of test scripts to test the application.

13. The apparatus of claim 12, wherein the program code executable by the processor to cause the apparatus to associate each test script of a set of test scripts with the indication of program code invoked by the test script comprises program code executable by the processor to cause the apparatus to:
for each test script in the set of test scripts, execute the test script on the application;
monitor the application during execution of the test script to identify program code of the first program code which is executed; and
associate the test script with the identified program code.

14. The apparatus of claim 13, wherein the program code executable by the processor to cause the apparatus to monitor the application during execution of the test script to identify program code of the first program code which is executed comprises program code executable by the processor to cause the apparatus to at least one of:
execute the application in a debugging mode;
monitor an instruction pipeline of a processor executing the application; and
initiate an agent to record instructions issued to the processor by the application.

15. The apparatus of claim 13 further comprising program code executable by the processor to cause the apparatus to:
instrument the first program code with a plurality of breakpoints;
wherein the program code executable by the processor to cause the apparatus to monitor the application during execution of the test script to identify program code of the first program code which is executed comprises program code executable by the processor to cause the apparatus to identify which breakpoints are encountered during execution of the test script.

16. The apparatus of claim 12 further comprising program code executable by the processor to cause the apparatus to eliminate a first test script from the subset of test scripts based, at least in part, on the first test script failing to invoke a first program code modification of the plurality of program code modifications more than a threshold number of times.

17. The apparatus of claim 12 further comprising program code executable by the processor to cause the apparatus to:
monitor the application during execution of the subset of test scripts to identify executed program code; and
based on a determination that the executed program code does not comprise all of the plurality of program code modifications, indicate that the application was not adequately tested based, at least in part, on not all of the plurality of program code modifications being tested.

18. The apparatus of claim 12, wherein the program code executable by the processor to cause the apparatus to identify the subset of the set of test scripts comprises program code executable by the processor to cause the apparatus to:
for each program code modification in the plurality of program code modifications,
query the indications of program code associated with the set of test scripts using an indication of the program code modification;
identify a first test script of the set of test scripts for which the indication of program code corresponds to the indication of the program code modification; and
add the first test script to the subset of test scripts.

19. The apparatus of claim 12, wherein the program code executable by the processor to cause the apparatus to determine the plurality of program code modifications comprises program code executable by the processor to cause the apparatus to:
compare the modified program code to the first program code; and
determine the plurality of program code modifications based, at least in part, on the comparison.

20. The apparatus of claim 12 further comprising program code executable by the processor to cause the apparatus to, based on a determination that the plurality of program code modifications exceeds a threshold, execute the set of test scripts to update the indication of program code associated with each test script.
